(19) United States
(12) Patent Application Publication
(10) Pub. No.: US 2002/0048412 A1
(43) Pub. Date: Apr. 25, 2002

(54) System and method for interpolating a target image from a source image

(76) Inventors: Finn Wredenhagen, Toronto (CA); Gary Cheng, Scarborough (CA); Ming Tse, Markham (CA)

Correspondence Address: FASKEN MARTINEAU DUMOULIN LLP, Toronto Dominion Bank Tower, Toronto-Dominion Centre, Box 20, Suite 4200, Toronto, ON, M5K 1N6, CA

(21) Appl. No.: 09/929,282

(22) Filed: Aug. 15, 2001

(30) Foreign Application Priority Data
Aug. 21, 2000 (CA) 2,316,610

(51) Int. Cl. G06K 9/64

(52) U.S. Cl. 382/278

(57) ABSTRACT

An interpolator for processing an image having, an array of pixels, the interpolator comprising a feature extractor for processing a pixel sequence contained in the array of pixels to extract visually significant features therein; a feature comparator for determining similarities between the extracted features in adjacent pixel sequences and; an alignment controller using said matched features to select visually most relevant source pixels to generate a target pixel.

The present invention relates to the field of image displays, and more particularly to a system and method for improved interpolation in digitized image displays.

### BACKGROUND OF THE INVENTION

Traditional raster display devices such as television monitors, video displays have offered few display option features such as image zooming, picture-in-picture and such like. However with the increase in digitization of video images there is an expectation that raster display devices offer such features. In the case of image zooming, the resolution of the image being displayed is seldom limited by the raster display resolution capabilities, but by the source image pixel resolution. Accordingly, many techniques have been implemented to improve the perceived resolution of digitized images, both to support the additional features demanded by users and to improve the overall clarity of the perceived image to the user.

A digitized image consists of a rectangular array of pixels having Rs row pixels and Cs column pixels. During image enlargement the information in a source image is used to create a now target image having RT row pixels and CT column pixels where typically Rs [symbol] RT and Cs [symbol] CT. That is, more pixels per row and per column are needed to satisfy the requirement of the new target image. Target pixels are usually generated by using interpolation, look-up tables or other known techniques.

Referring to FIG. 1 there is shown a two-dimensional array of source pixels (circles) and an anticipated target pixel (x) to be generated in a target row between successive rows of the source pixels. One way to generate the target pixel x would be to take one quarter of the value of the immediate neighbors and sum the result. However, it is difficult to decide on the ideal combination of source pixels and their associated weights. “Ideal” in this case depends on the strategy, rule, algorithm or method implemented to ensure that the enlarged image is most visually pleasing.

Often when computing the target pixel, in the absence of more suggestive information about the nature of the pixel data in a row, an assumption is made that the source pixels that are physically close to one another contain information that is the most similar. And, by extension, it is often assumed that the closer the source pixel is to the target, the more meaning it can impart on the final value of the target pixel's intensity. For example U.S. Pat. No. 5,703,968 describes a method and apparatus for detecting and computing the level difference between pairs of pixels surrounding the target pixel on an upper and lower line. The level differences are compared with each other and a line having a smallest level difference is detected an effective interpolation line information is generated. Similarly, in U.S. Pat. No. 5,991,463 there is described a multi point “filter” interpolator, or four-tap filter wherein interpolated unsampled target pixels are calculated as a function of four source pixels and a parameter representing the distance of the desired pixel from a source pixel.

This technique is limited however when applied to a solid diagonal line that has been digitized and displayed on a raster-imaging device. Closer inspection of the components that comprise the diagonal line reveals that the line is made up of a series of shifted horizontal line segments as shown in FIG. 2(a). In many applications, and in image enlargement in particular, it is very important to identify the horizontal (vertical) offset between rows (columns) so the data in the image can be properly interpreted.

Although the problem of maintaining the perceived resolution of an image using a correlation-based algorithm is applicable to progressive scan and interlaced images, its proper use most strongly influences the quality of an image when an image is interlaced such as is the case in interlaced video. For instance, an interlaced image frame of 2N lines has two fields of N lines per field. When the image content is static in both fields, the effective resolution is 2N lines. But when the image content is in motion, the effective resolution drops to N lines in general, due to the temporal latency between fields. In regions where the image content contains less detail, the loss in resolution is less perceptually significant. In regions where the image content has detail, i.e. where the correlation function between row or column pixel data is sensitive to a spatial displacement the reduction in perceived resolution can be quite noticeable.

For example as shown schematically in FIG. 2(a), if we were to interpolate vertically by taking a linear combination of the pixel immediately above and immediately below the gaps between the lines in FIG. 2(a), we would end up with a deinterlaced (or scaled) image as shown in FIG. 2(b). Clearly this is an unacceptable image quality. Thus, the different ways in which data is interpolated has a large impact on the perceived resolution of the image.

Accordingly, there is a need for a system and method that allows the deinterlacing of images for enlargement while maintaining its perceived resolution when redisplayed.

### SUMMARY OF THE INVENTION

The present invention seeks to provide a method of interpolation for maintaining the perceived resolution of a digitized image when the image is enlarged.

In accordance with the invention there is provided an interpolator for processing an image having an array of pixels, the interpolator comprising a feature extractor for processing a pixel sequence contained in the array of pixels to extract visually significant features therein; a correlator for determining similarities between the extracted features in adjacent pixel sequences and; an alignment controller for generating a position of a target pixel based on the output of the correlator, such that the interpolated target pixel is generated from the visually most relevant source pixel data.

In a preferred embodiment the feature extractor is implemented with a state machine. The features are identified by observing pixel sequences of row or column pixel data. The method of interpolation is similar to identifying regions of correlation between pixels, but it does so by first extracting features and then determining whether those features belong together. The similarity, or correlation, between extracted features is due to a visually significant structure, such as a for example, a line, edge or ramp, of arbitrary orientation.

The interpolation process uses feature-based comparison to maximum visual benefit and includes a process for identifying and storing specific characteristics of an image for later use.

### BRIEF DESCRIPTION OF THE DRAWINGS

An embodiment of the present invention will now be described by way of example only with reference to the following drawings in which:

FIG. 1 is a schematic diagram of a pixel array;

FIGS. 2(a) and (b) are schematic diagrams of a digitized diagonal line;

FIG. 2(c) is an interpolated image of the line using a vertical filter interpolator according to the prior art;

FIG. 3 is a flowchart of the process of interpolation according to the present invention;

FIG. 4 is a schematic diagram of the digitized diagonal line of FIG. 2(a) generated in accordance with an interpolation process of the present invention;

FIG. 5 is a schematic diagram showing increasing intensity values in a pixel sequence characterizing an upward ramp feature;

FIGS. 6(a) and (b) are schematic diagrams of a flow chart and bubble diagram for a state machine for processing an upward ramp feature;

FIG. 7 is a schematic diagram showing intensity values in a pixel sequence characterizing a level segment feature;

FIGS. 8(a) and (b) are schematic diagrams of a flow chart and bubble diagram for a state machine for processing a level segment feature;

FIGS. 9(a) and (b) show a flow chart and bubble diagram for implementing downward

FIGS. 10(a) and (b) are graphical representations of an intensity profile in adjacent lines of pixels in an image;

FIG. 11 is a flow chart showing a matching algorithm;

FIG. 12 is a schematic diagram showing the interpolating process using a pivot pixel;

FIG. 13 is a schematic diagram showing sub-pixel interpolation using a target pixel;

FIG. 14 is a flow chart showing a process for computing relative shifts; and

FIG. 15 is a schematic diagram of an interpolator according to an embodiment of the present invention.

### DETAILED DESCRIPTION OF THE PREFERRED EMBODIMENTS

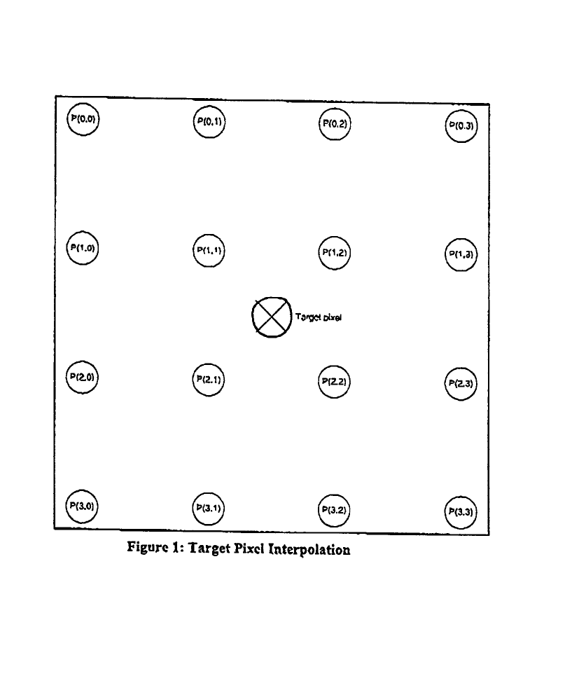

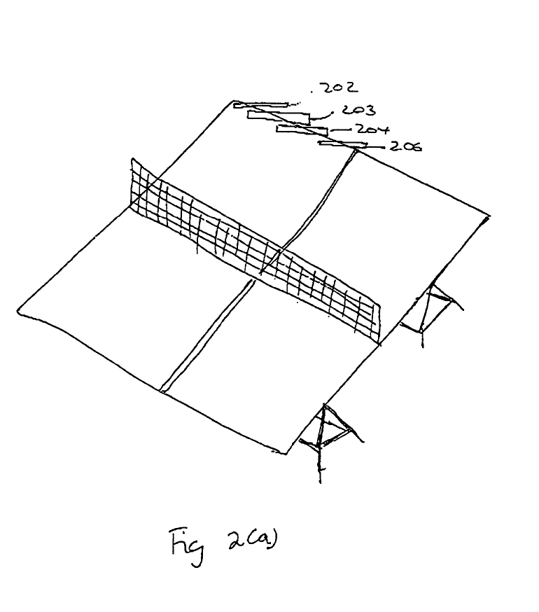

In the following description like numerals refer to like structures in the drawings. The schematic diagram of a pixel array shown in FIG. 1 will be used in the following description to more clearly illustrate the concepts of the subject invention Referring now to FIG. 3 there is shown a generally at 300 a block diagram of an interpolator according to an embodiment of the present invention. The interpolator 300 comprises a feature extractor 302 for identifying visually significant features in a pixel sequence contained in an array of pixels 304 and based on predetermined threshold criteria 308, a feature comparator 306 for generating a correlation between the extracted features in adjacent rows or columns of pixels and an alignment controller 310 for determining pixels to be used in generating the target pixel T based on the output of the feature comparator 306, such that correlation is used to maximum visual benefit in computing the value of the target pixel. In the following description each component of the interpolator 300 is described in detail along with worked examples of their operation.

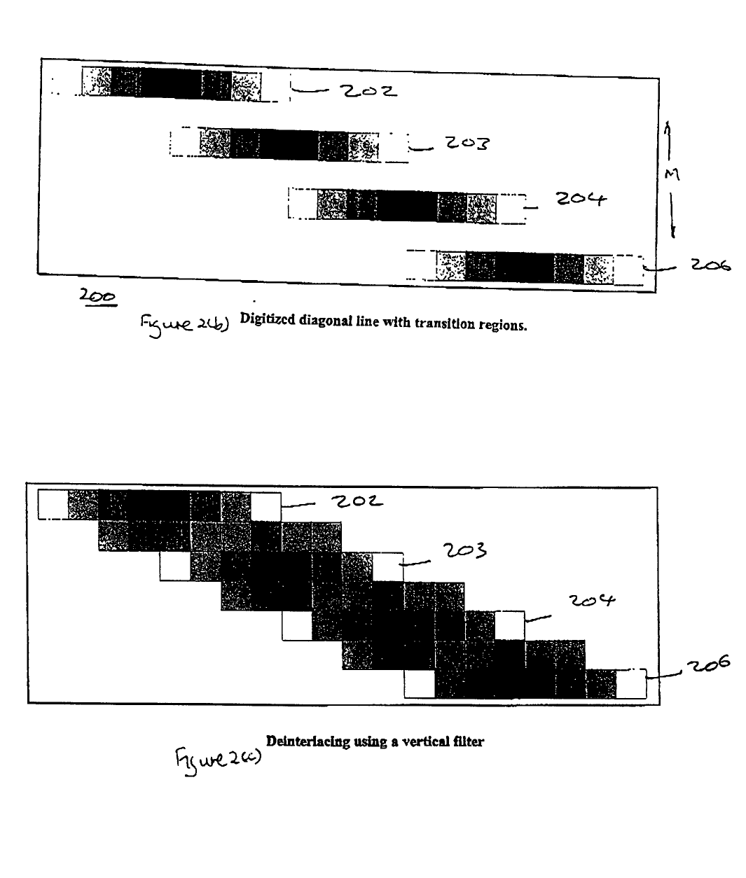

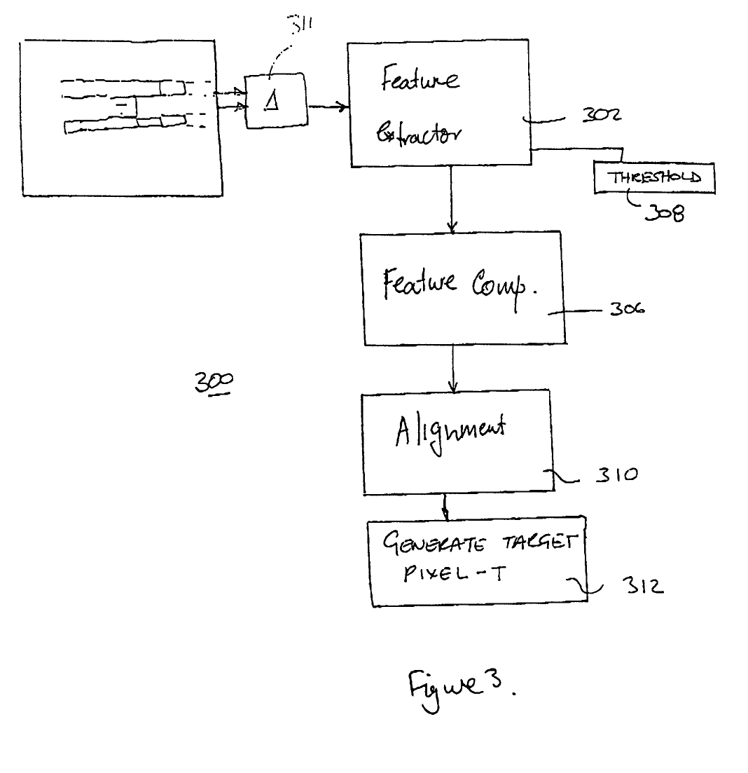

Referring back to FIG. 2(a) there is shown a schematic diagram of a portion of an image 200 containing a solid diagonal line that has been digitized and displayed on a raster-imaging device shown schematically in FIG. 2(b) The image generally consists of an N by M pixel array. Closer inspection of the component pixels that comprise the diagonal line reveals that the line is made up of a series of shifted horizontal line segments 202, 203, 204 and 206. In many applications, and in image enlargement in particular, gaps between the lines have to be filled-in. It is important to identify the horizontal (or vertical) offset between rows (or columns) so the data in the image can be properly interpreted by the viewer. During interpolation, for example, the perceived resolution will be better if the orientation of the line is known and an interpolation filter is aligned to take advantage of the image or feature orientation.

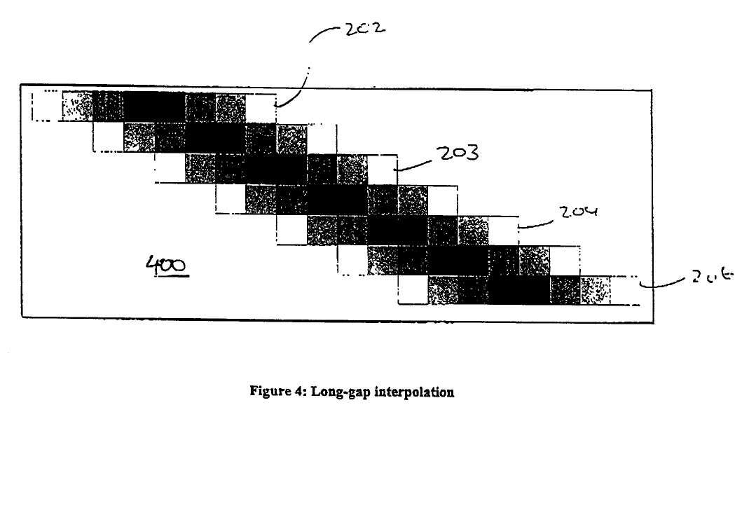

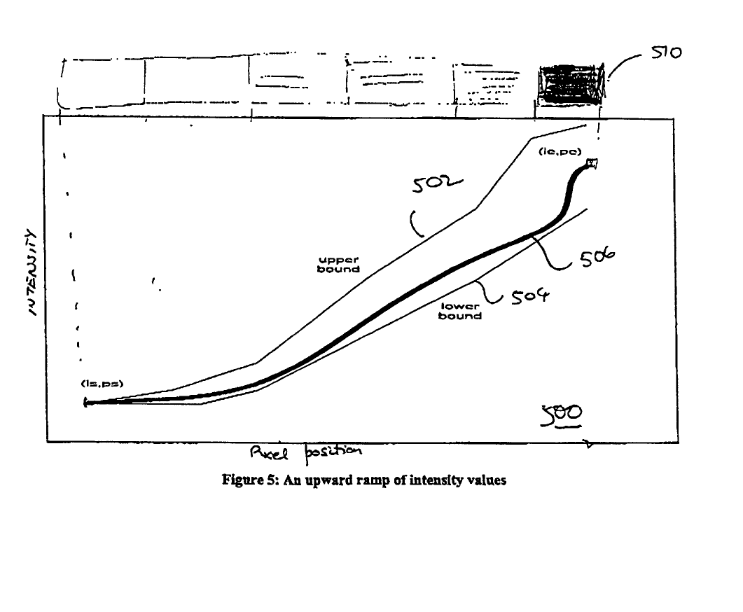

The present invention provides an improved interpolation system that uses pixels whose information content is the most alike, and not necessarily pixels that are physically close. Accordingly, if a filter is applied to the original pixel with an understanding that pixels in subsequent rows are misaligned by five pixels horizontally, computing the intermediate row by interpolation results in the image shown in FIG. 4. Clearly this directional interpolation method results in an image that recovers the digitized line more faithfully than the interpolation used to derive the image shown in FIG. 2(c). The perceived resolution has been maintained during deinterlacing (enlargement). This requires that the relative shift in the feature of interest in the image is determined. That is, pixels whose content is alike, or more precisely, belong to the same feature, must be identified and connected during interpolation. In order for this to happen, many difficult problems must be overcome and as will be described below.

For the purposes of the present discussion we will assume that, as shown in FIG. 1, pixel data enters from the top right, P(0,3), and exits at the top left P(0,0). Once a row of pixel data has passed across the top row, it is re-circulated and appears on the second row, P(1,*), again entering from the far right, P(1,3), and exiting at the left, P(1,0). In this way, a row of pixel data, held in a line store register, becomes the next row of pixel data after a one-line delay.

In order to generate the feature information, a difference circuit component 301 computes the change in intensity between adjacent pixels in the same row. That is, Δ=P(Rᵢ,Cⱼ)−P(Rᵢ,Cⱼ₋₁), where Rᵢ is the ᵢth row and Cⱼ is ⱼth column. Thus, for the first two pixels in row 1: Δ=P(0,1)−P(0,0).

The value of Δ is used throughout the feature extraction process.

The feature extractor 302 (FE), or as it is also known, Feature Identification, performs a process whereby specific characteristics of the image are identified and which may be recorded for later use. When enlarging an arbitrary image, the most important features in an image, on a line-by-line basis, are usually, but not limited to, a ramp (a succession of either increasing or decreasing intensities), edges (a large change in intensity, sometimes called a step) and a level segment (a series of successive intensities that are relatively constant). There are other features such as noise, spikes and so on, which can also be identified and stored for subsequent use.

In one embodiment a state machine (SM) is used to detect a specific feature. The targeted feature for extraction is user-definable and, therefore, programmable, so alternative definitions of specific features can be changed in a dynamic manner. In the following description, we will restrict the discussion of feature extraction to a row of data, but it is acknowledged that the method described herein applies equally well to column data.

In FIG. 2(b) a single row of pixel data may be used to illustrate the operation of a state machine. The row of pixel intensity data 202 in FIG. 2(a) has three components: a downward segment (white to black ramp), a level segment (Black-Black) and an upward segment (black to white). Here the terms “downward” and “upward” are merely used to describe increases or decreases in pixel intensity. A state machine is used to extract specific portions of the intensity data. Separate state machines are used to identify specific features such as level segments and upward ramps. Other segments may also be identified, however, for illustrative purposes, the following discussion will be limited to the segment types described above.

The state machine uses basic hardware components such as adders and comparators to perform the feature extraction operations. The state machine flow control decisions use these components in any way, thereby rendering the state machine fully programmable. Thus, alternative flow control algorithms can be programmed in the state machine to look for level segments, or other features of interest, in a flexible manner.

In general, if N different features are to be identified, N state machines are required, although depending on the precise definition of the features will need to be identified, fewer state machine may be needed. The state machines are independent and operate concurrently so the approach lends itself to easy expandability. Adding more state machines, as required, it easy within the current framework provided it is accompanied by the necessary hardware. This approach also lends itself easily to a software implementation.

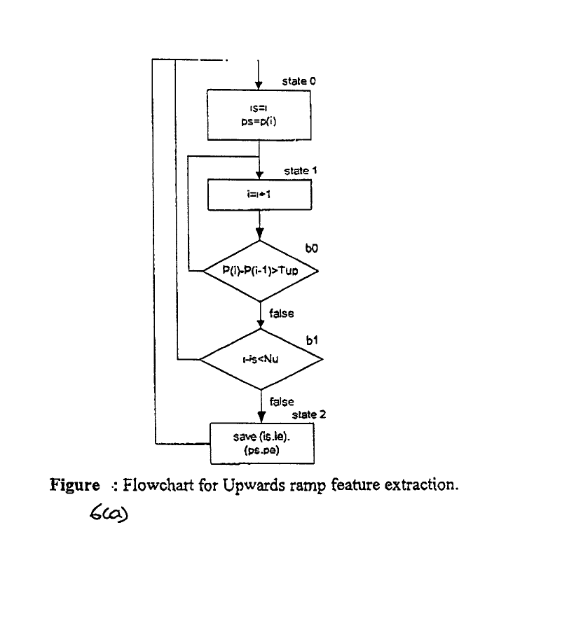

Referring to FIG. 5 there is shown a sequent of pixels 510 and a trajectory of its intensities 506 characterizing an upward ramp. The trajectory 506 is bounded above and below by thresholds 502 and 504. These thresholds are user-defined. For the purposes of discussion, we can define an upward ramp so that it must satisfy the constraints:

a. successive intensities must be increasing by a positive minimum threshold;

b. the above must bold for some minimum number of pixels;

c. there may be a finite number of exceptions to (a)

d. the trajectory of intensities must be contained within an upper and a lower threshold; and

e. there may be a finite number of exceptions to (d).

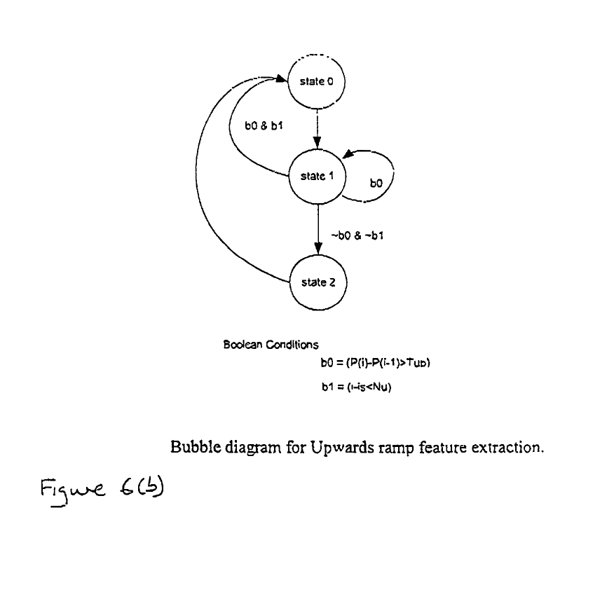

Referring to FIG. 6(a), there is shown a flow chart of state machine for implementing an upward ramp 506.

Nu is a user-defined parameter that sets the maximum number of violations permissible before the candidate upward segment is rejected. A violation, in the context of the flowchart, is a set of pixels that do not meet the criterion: p(i)−p(i−1)>Tup; Tup is a user-defined parameter that defines the threshold value for a upward step;

Referring to FIG. 6(b), there is shown a bubble diagram for implementing the flow chart of FIG. 6(a). The states have the following behaviour for the upward ramp state machine.

State 0

N=0

Ps=p(i)

is=i

State 1

i=i+1

State 2

Save the values that correspond to the starting point (is,ps) and ending point (ie,pe) where ie=i−1 and pe=p(i−1) before returning to state 0.

Note that Nu is the number of consecutive upward steps needed to qualify as a ramp. Tup is the size of each step.

In a similar way in which the ramp was defined above, we can define a level segment. Although there is no unique way to define a Level segment, an example of one definition is given below.

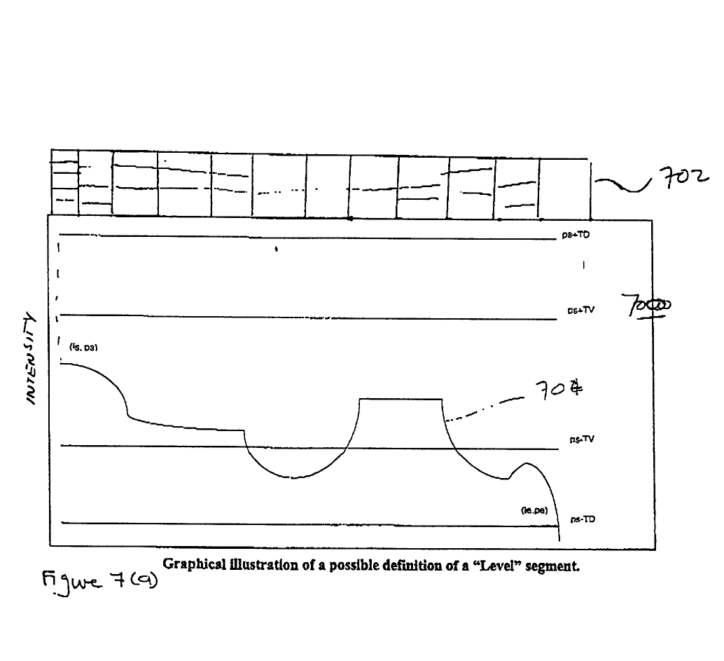

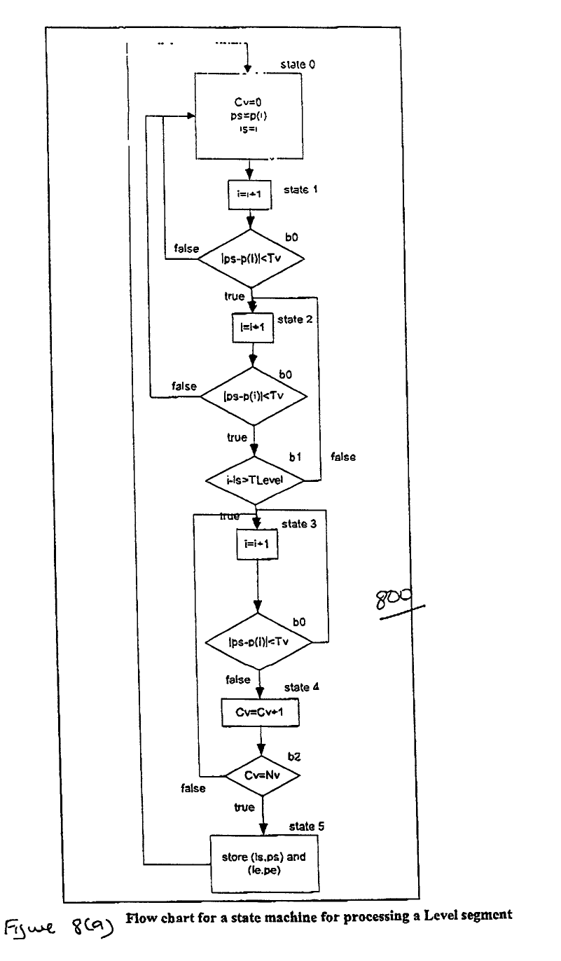

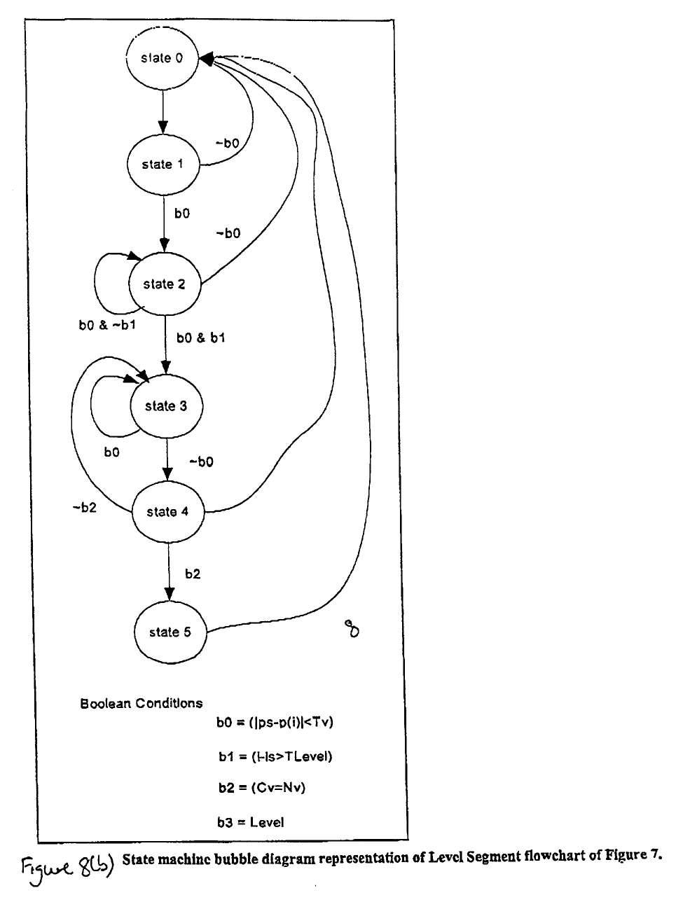

Referring to FIG. 7(a) there is shown a typical row of pixels defining level sequent 702, and accompanied by a threshold plot 704. In general, a level segment may be determined by applying the following list of criteria:

(a) the locus of intensities (the intensity trajectory) following a staring point (ps) must lie within a band defined by (ps−TV,ps+TV) for at least NL pixels, where ps is the potential start location of the level segment; TV is a user-defined violation threshold (typically this is set to about three and is useful to counter the effects of noise);

(b) there may be at most NT violations of the band threshold. Here NT is a user-defined threshold that places a maximum number of threshold violations of condition (a);

(c) there may be no more than NCT consecutive intensity values beyond the threshold band defined in (a). NCT is a user-defined threshold that places a maximum number of consecutive allowable violations before the candidate level segment is rejected; and

(d) if at any time the trajectory of intensities ventures beyond the confines of the threshold band defined by (ps−TD,ps+TD) the candidate level-segment is ended. TD is a user-defined threshold defining the permissible region in which a level segment must lie as defined by ps before it is rejected (disqualified).

The band defined in (a) above provides the ability to build in a flexible forgiveness factor. This is useful in the event the intensity values are corrupted by noise and more noise immunity is required. If the locus of intensities has satisfied all constraints, then a Level feature is deemed to have occurred. Its starting (is) and ending (ie) locations and starting and end intensities (ps) and (pe) are stored for later analysis.

Referring to FIGS. 8(a) and (b), there is shown a flow diagram 800 and a bubble diagram 810 for implementing a Level segment feature extraction according to an embodiment of the present invention In FIG. 8(b), the following operations take place in each of the states:

State 0

Cv=0

Ps=p(i)

is=i

State 1, 2, and 3

i=u+1

State 4

Cv=Cv+1

State 5

Store the starting point location and ending locations is and ie, and the respective starting and ending pixel intensities ps and pe.

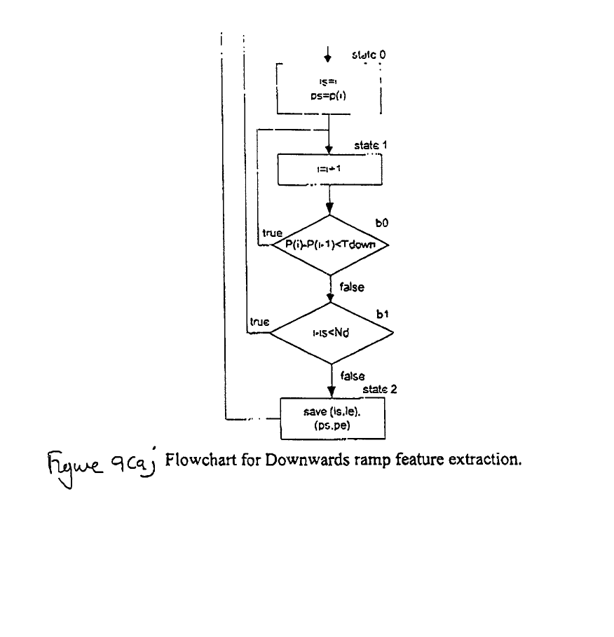

Referring to FIGS. 9(a) and 9(b), there is shown a flow chart and bubble diagram for an algorithm executed by a state machine used to detect the presence of a downward segment. The following parameters are used in the diagrams.

NV is a user-defined parameter that sets the maximum number of violations permissible before the candidate downward segment is rejected. A violation, in the context of the flowchart, is a set of pixels that do not meet the criterion: p(i)−p(i−1)>Tdown;

Cv is the count that contains the current number of violations.

Tdown is a user-defined parameter that defines the threshold value for a downwards step;

Ndown is a variable that contains the number of downwards steps taken in the current candidate downward segment.

The upward trend state machine uses the same logic, except the polarity of the thresholds and comparisons is reversed.

The states in FIGS. 9(a) and 9(b), have the following behaviour for the downward ramp state machine.

State 0

N=0

Ps=p(i)

is=i

State 1

i=i+1

State 2

Save the values that correspond to the starting point (is,ps) and ending point (ie,pe) where ie=i−1 and pe=p(i−1) before returning to state 0.

Note that Nd is the number of consecutive downward steps needed to qualify as a ramp. The magnitude of Tdown is the size of each step.

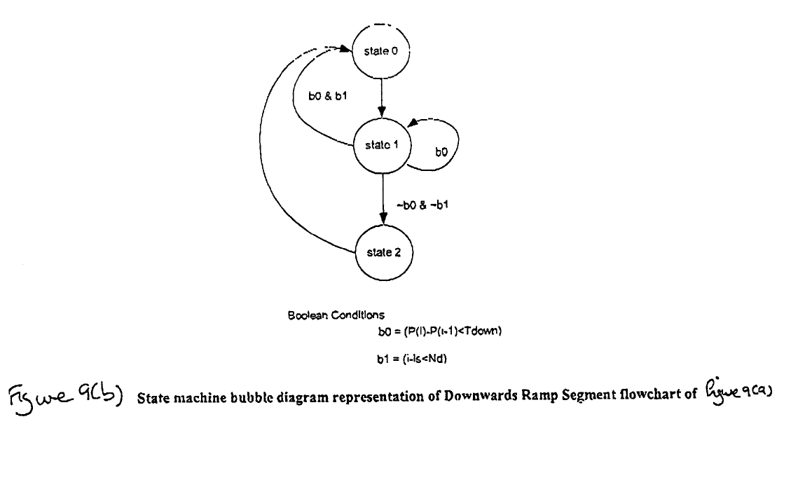

The operation of the interpolator 300, can be more clearly understood by referring to a specific example. Referring to FIGS. 10(a) and 10(b), there is shown a series of pixel intensities that correspond to image segments in FIG. 2(b).

The Feature Extractors (FE) 302 processes pixel data arranged in a two-dimensional array or matrix having elements P(ij). Each row in the matrix is denoted by P(i,*),—a one-dimensional sequence of intensities similar to those shown in FIG. 2(b).

The Feature Extractors 302 log the Downward, Level and Upward segments to a feature table (Table 1) for rows 1 and 2, where the number represent intensity values on an arbitrary scale of 0 to 255.

TABLE 1

| | S1 | E1 | S2 | E2 | S3 | E3 | S4 | E4 |
|---|---|---|---|---|---|---|---|---|
| Intensity | 255 | 5 | 5 | 5 | 5 | 255 | — | — |
| (Row 1) | | | | | | | | |
| Intensity | 255 | 255 | 255 | 5 | 5 | 5 | 5 | 255 |
| (Row 2) | | | | | | | | |
| Position | 6 | 19 | 19 | 25 | 25 | 42 | — | — |
| (Row 1) | | | | | | | | |
| Position | 3 | 17 | 17 | 30 | 30 | 36 | 36 | 53 |
| (Row 2) | | | | | | | | |

The elements in the table comprise a pair-wise grouping of numbers (start position S1, start intensity E1) and (end position S2, end intensity E2) in Table 1 correspond to a feature that has been extracted and logged to the Feature Table. For example in row 1, positions 7 through 20 correspond to a downward ramp. Each time a feature is identified in the source data, it is logged to the Feature Table. Should the Feature Table become full, a “Feature Table Full” flag will be set. Usually, eight (8) bits are needed to represent intensity data and eleven (11) bits are needed for the pixel positioning. These numbers are format dependent in general.

Once the feature table is compiled, the Feature Comparator 306 attempts to match like features held in two adjacent rows in the Feature Table 1.

After the first row of pixel data has passed, all features of interest have been extracted and logged to the Feature Table. Immediate thereafter, the second row of pixel data arriving at P(0,2) is examined and the features it contains are extracted. And at the same time, the Feature Comparator 306 is attempting to match like features. If a match is found, it is stored in a Matched Table (Table 2). The information in the Matched Table is used later on by the Alignment Controller 310.

The operation of the Feature Comparator 306 maybe understood by comparing the set of intensities FIG. 10(a) with those of FIG. 10(b). FIG. 10(b) shows the intensity profile on row 2 which is one line store in advance (earlier in time) of row 1. Table 2 shown the corresponding extracted feature information.

The Feature Comparator 306 implements an algorithm that attempts to determine whether rows ‘0’ and ‘1’ are correlated, and further, which segments or features belong together (constitute a match). Clearly the pixel data in row ‘0’ and row ‘1’ is correlated, since their intensity profiles are very similar except for the horizontal positional shift. Some restrictions may be placed on the search so that only segments within a window of N pixels are compared.

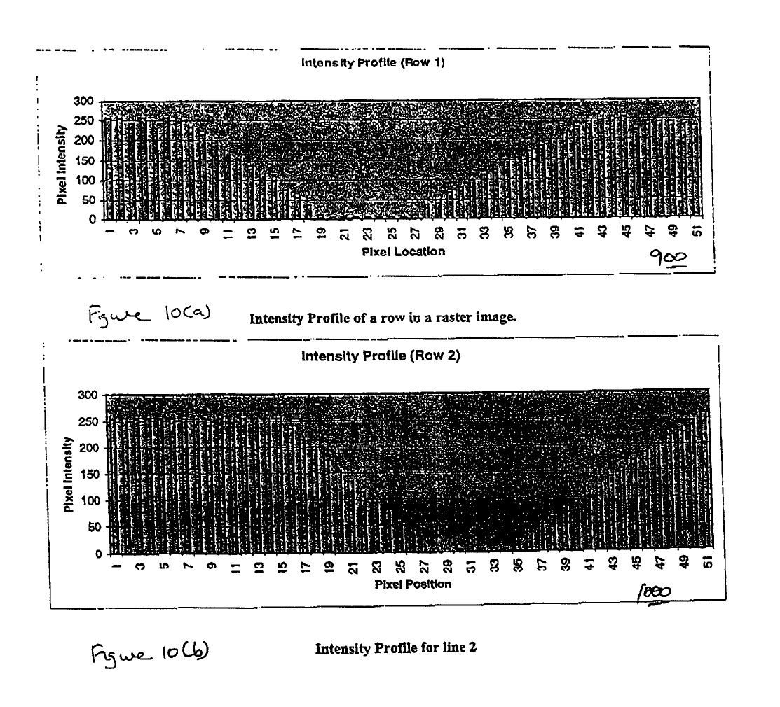

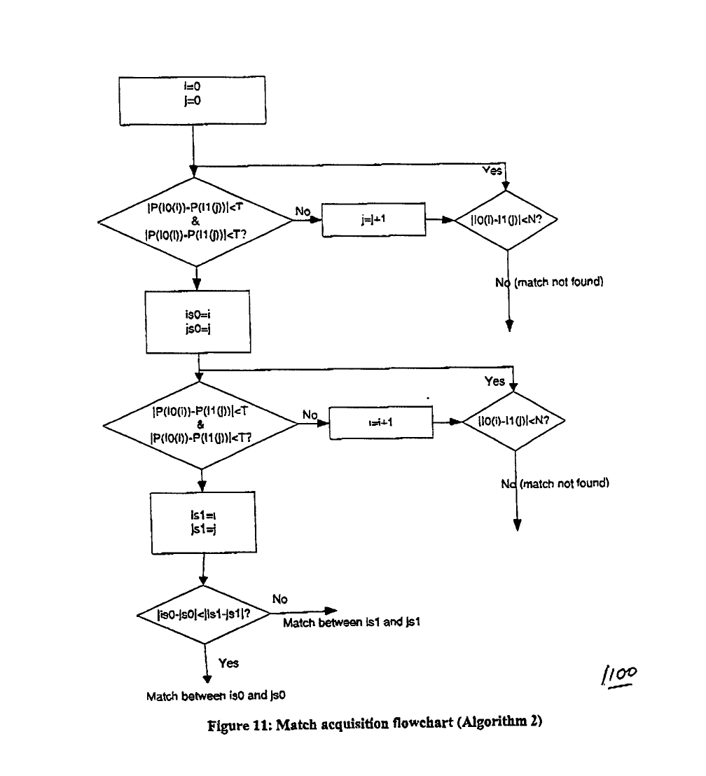

Referring to FIG. 11, there is shown a flow chart of a matching algorithm 1160 according to one embodiment of the present invention. The matching algorithm may be described as follows: Let P(0,i), P(1,j), I(0,i) and I(1,j) represent the pixel position and pixel intensities for rows 0 and 1, respectively. Let the window N size that limits the search region be equal to twenty five (25) pixel. Then the possible matches for the segment (S1,E1) from row 1 are (S1,E1), (S2,E2) and (S3,E3) from row 2 as S1(row 1)-S2(row 2)<25. To determine whether a match exists, each pair of intensities must match to within a chosen tolerance T. If T=20, then clearly, abs[I(0,0)-I(1,0)] and abs[I(0,1)-I(1,1)]>T so no match exits for these segments. The next candidate segments for reveals that abs[I(0,1)-I(1,1)] and abs[I(0,2)-I(1,2)]<T so there is a match.

To ensure that the nearest matched pair has been found, another search must take place over the alternate row keeping the segment in row 2 constant and finding the nearest matching segments in row 1. If another match is found, then the nearest positional match is deemed the match.

It is not difficult to extend the matching algorithm to include three rows (columns) of pixel data. In addition, a predictive circuit can be employed that estimates the next correlated feature based on the previous two matches.

The matching indices are stored in the Matched Table as shown in Table 2. Table 2 contains paired indices of matching segments for Table 1.

TABLE 2

| | | | | | | |
|---|---|---|---|---|---|---|
| Position Row 1 | 6 | 19 | 19 | 25 | 25 | 44 |
| Position Row 2 | 17 | 30 | 30 | 36 | 36 | 53 |

The matching algorithm finds the initial bearing of the segments in the Feature Table. It must be run at the onset of new row data or when the trend bearing is lost. Once the bearing has been established, it is possible to match segments without resorting to a two-sided iterative search. As long as trend segments are properly tracked, the bearing portion of the match need not be invoked. Matched segments are removed from consideration in subsequent matching.

In general, Table 2 will contain one extra bit of information indicating whether or not a region corresponds to a non-transition segment and possibly information needed for sub-pixel interpolation. Sub-pixel interpolation is explained later. In our example, such an overlap is absent.

Once the features in adjacent rows are matched, an alignment controller (AC) 310 computes the sequence of relative horizontal shifts that are needed between adjacent rows in order to bring matched transition segments into alignment. The aligned segments may then be processed using one of many standard interpolation methods or filters to determine the value of the target pixel.

After the trend bearing is found, and the Matched Table is populated, phase information is used to compute the relative shift needed to align matching transition segments. In order to understand how the alignment controller computes the sequence of relative shits, we will need to introduce two terms namely: Transition Segment and Pivot Pixel.

A Transition Segment (TS) is a segment that exhibits changes in intensity that is not a Level. Thus upward or downward ramps or variations thereof may be characterized as Transition Segments. A matched Transition Segment is distinct from a non-Transition Segment in that it is only when such segments are actively participating in interpolation that the desired relative shift between rows is not necessarily zero. Alternatively, the desired alignment of a filter input is not necessarily vertical.

The pivot pixel (PP) is a pixel in the matched segment that defines the beginning or end of a matched transition segment. For example, referring back to Table 2, the matching segments are A2 and B3. A2 is the pivot pixel position because I0(i)=1<I1(j)=11.

Referring to FIG. 12, there is shown a schematic diagram or a pair of adjacent lines of source pixel 1202 and 1204. A line of target pixels 1206 is shown bounded on the top by the top pixel row 1202 and at the bottom by the bottom pixel row 1204. As may be seen, in order to generate a value for successive target pixel, the pivot pixel is used repeatedly with the bottom row pixels until the pivot pixel in the bottom row has been shifted into alignment with the top row pivot pixel. Following alignment, the orientation of interpolator filter is maintained throughout the transition segment until either the next pivot pixel or a matched non-transition segment is encountered.

The operation of the alignment may be described as follows. A straight line is cast from the pivot pixel (PP(i)) through a target pixel (x). The line intercepts the adjacent source row at a bounding pixel. The bounding pixel location will not always coincide with a source pixel. In order to generate the desired bounding pixel, a technique known as sub-pixel interpolation is used.

Sub-pixel interpolation is used to generate an effective bounding source pixel where there is none. To generate such a pixel, interpolation is performed in a non-separable manner. This means that horizontal and vertical interpolation takes place concurrently. To better understand why sub-pixel interpolation is required consider the equation of a line originating at the pivot pixel PP(i) and which passes through a target pixel. The equation for this line is:

K₁(Kₚ)=(Kₚ−K₀)/φ+K₀, K₀ [symbol] Kₚ [symbol] K₁.

Where Kₚ the column index of the target pixel, K₀ is the pivot pixel and K₁ is the end of the transition segment. Sub-pixel interpolation is needed when K₁(Kₚ) is not an integer. The phase φ has a large influence on the value of K₁(Kₚ). For example, referring to Table 1, the equation of the line that described the feature frontier is Y(K)=(Kₚ−6)/11.

Sub-pixel interpolation arises in two situations:

i) when Y(1) is not an integer, and

ii) when (Kₚ,φ) is too close to the target pixel boundary.

Condition ii) is most dramatic when, for example, φ=0.5, and the number of pixels between K₀ and K₁ is a small even number. In what follows we will focus on i).

Let φ be the phase between 0 and 1. Let Kₚ be the column position of the target pixel. Let us assume that matching segments have been shifted so the transitions regions are aligned to within one pixel . The target pixel can be thought of as lying anywhere within the four bounding pixels. The weights of the four bounding pixels must be chosen so that they coincide with the location of the target pixel.

Given the pixels values P(1,1), P(1,2), P(2,1) and P(2,2), the phase φ, we want to compute the target by interpolation between P(1,1) and P(1,2) and between P(2,1) and P(2,2). Therefore, we must compute:

Z₁=(1−a)*P(1,1)+a*P(1,2)

Z₂=(1−b)*P(2,1)+b*P(2,2)

Target=(1−φ)*Z₁+φ*Z₂

Where a and b are weights such that 0 [symbol] a, b [symbol] 1. These conditions will give a target pixel with twice the desired intensity. In addition, sub-pixel interpolation, as written above, is a two-step procedure. We can rewrite the above so that

Target=(1−φ)*((1−a)*P(1,1)+a*P(1,2))+φ*((1−b)*P(2,1)+b*P(2,2)).

This is interpolation that takes one step. It allows the target pixel to reside anywhere within the four corner points (P(1,1), P(1,2), P(2,1), P(2,2)). In general, the weights a and b are related to the phase φ which can lead to simplifications, but there are still problems with which we must contend. Namely,

i) additional run-time multiplies are required;

ii) the resultant weights may no longer have unity gain.

Two alternative solutions are suggested.

A first alternative may use an existing low pass filter (on chip) to approximate the location of the target pixel. Then, by independently flipping the filter weights associated with pixels P(1,0) and P(1,1), P(2,1) and P(2,2), it is possible to reach a much larger region of potential target pixel locations. The phase φ will determine the tap weights, and K₁(Kₚ) determines the horizontal intercept, which in turn, determines whether the weights should be flipped. Flipping the weights requires multiplexors.

A second alternative is similar to the first alternative, but it employs a dedicated m by n coefficient matrix whose entries act to quantize the square [0,1]×[0,1] into discrete cells. The fractional portion of the shift, i.e. K1(Kp)−└K1(Kp)┘, where └t┘ is the largest integer less than t, and the phase φ are used to address the coefficient cell in which the target resides. Table 3 shows a small table of coefficients that can be used for sub-pixel interpolation.

TABLE 3
Sub-pixel interpolation weights with pivot pixel located at w0 for
φ = 0.5.

| Index | w₀ | w₁ | w₂ | w₃ |
|---|---|---|---|---|
| 0 | 4/8 | 0 | 4/8 | 0 |
| 1 | 4/8 | 0 | 1/8 | 3/8 |
| 2 | 4/8 | 0 | 2/8 | 2/8 |
| 3 | 4/8 | 0 | 3/8 | 1/8 |
| 4 | 4/8 | 0 | 0 | 4/8 |

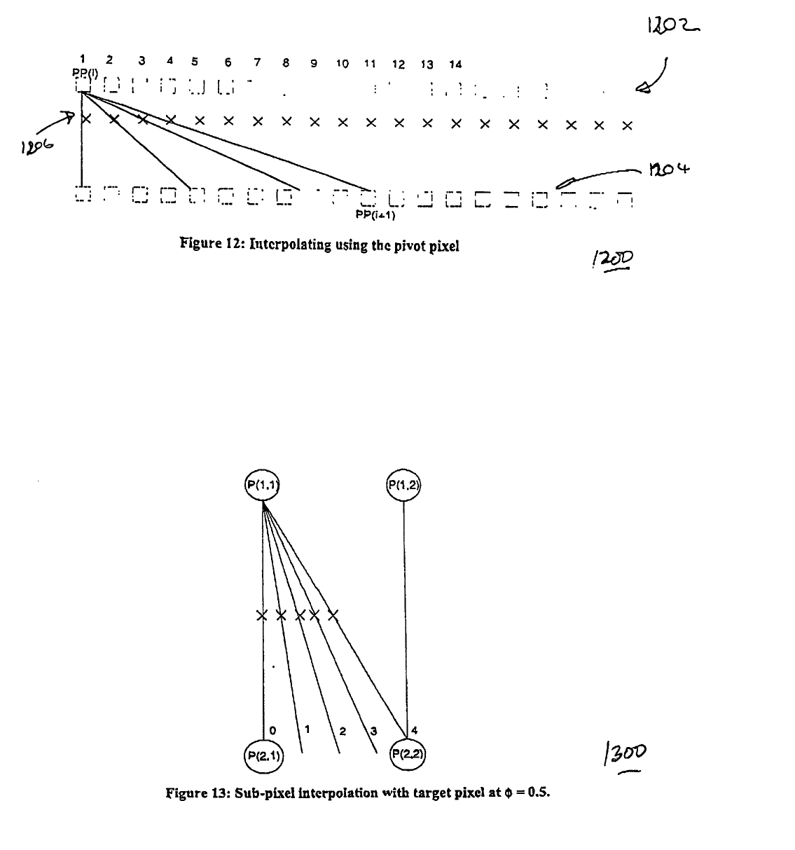

The weights w₀, w₁, w₂ and w₃ in Table 3 coincide with pixels P(1,1), P(1,2), P(2,1) and P(2,2) in FIG. 1. The index entry in Table 3 and FIG. 13 shows how to attain various targets. Due to a horizontal shift the pixels P(2,1) and P(2,2) may actually correspond to P(2,1+R) and P(2,2+R) for R>0.

The second alternative is preferred because it provides more control over the exact location of the target.

In conjunction with Table 3, we can see how the weights and pivot pixel P(0,0) are used in sub-pixel interpolation. The pivot pixel provides the total contribution for row 1. The phase of the target pixel is 180 degrees because w₀+w₁=w₂+w₃. Table 3 can be further reduced to three rows and half the number of columns by exploiting the property of skew symmetry. Added multiplexors will be required as a consequence to independently toggle the weights.

The effect of phase is an important input into the Alignment Controller 310. In this section two examples are given that demonstrate how to compute bounding and target pixels. We show how the relative shifts are generated with and without the use of sub-pixel interpolation.

Let Kₚ be the current column index of the interpolated pixel. Let AS be the accumulated shift, S be the shift and TS be the total shift. In order to determine the shift required for a given Kₚ, we must solve for Y(Kₚ)=1. Then,

K₁(Kₚ)=(Kₚ−K₀)/φ+K₀, K₀ [symbol] Kₚ [symbol] K₁

Here K₁ is the beginning or end of the transition segment at row 2.

### EXAMPLE 1

Segment alignment

In this example, K₀=6, K₁=17 so TS=17−6=11, φ=0.25; RS=TS=11, AS=0.

TABLE 4
Computation of relative shifts for Table 3 with φ = 0.5 (180 degrees)

| Kₚ | S | RS | AS |
|---|---|---|---|
| 6 | 0 | 11 | 0 |
| 7 | 4 | 7 | 4 |
| 8 | 4 | 3 | 8 |
| 9 | 3 | 0 | 11 |

The details of the computation are as follows:

Kₚ=6.

K₁(6)=(6−6)/0.25+6=6;

S=K₁(6)−K₀−AS=0.

RS=RS−S=11;

AS=AS+S=0;

Kₚ=7.

K₁(7)=(7−6)/0.25+6=10;

S=K₁(7)−K₀−AS=4.

RS=RS−S=7;

AS=AS+S=0+4=4;

Kₚ=8.

K₁(8)=(8−6)/0.25+6=14;

S=K₁(8)−K₀−AS=4.

RS=RS−S=7−4=3;

AS=AS+S=4+4=8;

Kₚ=9.

K₁(9)=(9−6)/0.25+6=18>K₁=17 so S=K₁−14=17−14=3.

S=3

RS=RS−S=0;

AS=AS+S=4+4=11;

In this example, Transition Segment alignment requires two shifts of four pixels and one shift of three pixels. The third shift brings the intercept location (for row 2) past the segment boundary, and so the final shift is three, and not four. After four successive shifts the matched segments are aligned. These steps are summarized in Table 4 above.

The Alignment Controller entries are shown in Table 5 for Alignment Controller entries for phase adjusted feature alignment for Table 3 for φ+0.25 (90 degrees).

TABLE 5

| Index | 6 | 7 | 8 | 9 |
|---|---|---|---|---|
| Shift Row 1 | 0 | 0 | 0 | 0 |
| Shift Row 2 | 0 | 4 | 4 | 3 |

### EXAMPLE 2

Segment alignment with sub-pixel interpolation

In this example we introduce the notion of sub-pixel interpolation. This is required when the relative shifts required for alignment are not whole numbers.

Let K₀=6 and K₁=17, then TS=17−6=11, RS=11, AS=0 and φ=0.22. Without loss of generality, we assume that K₀ is the origin.

Kₚ=0.

AS₀=0;

┌AS₀┐=0;

S₀=┌AS₀┐=0

RS₀=11

Kₚ=1.

AS₁=AS₀+1/0.22=4.5454

X₁=round(AS₁)=5

P₁=X₁−X₀=5−0=5

S₁=min(P₁,RS₀)=min(5,11)=5

RS₁=RS₀−S₁=11−5=7;

Kₚ=2.

AS₂=AS₁+1/0.22=9.0909

X₂=round(AS₂)=9

P₂=X₂−X₁=9−5=4

S₂=min(P₂,RS₁)=min(4,7)=4

RS₂=RS₁−S₂=7−4=3;

Kₚ=3.

AS₃=AS₂+1/0.22=13.6363

X₃=round(AS₂)=14

P₃=X₃−X₂=14−9=5

S₃=min(5,RS)=min(5,3)=3

RS₃=RS₂−S₃=3−4=0;

At Kₚ=1, a shift of 4.5454 is needed, but it is not possible to shift by this amount. In order to produce an effective shift of 4.5454, we must first shift by 4, and use sub-pixel interpolation to produce an effective shift of 0.5454. The target point is given by:

Target=(1−φ)*P(1,1)+φ*((1−0.5454)*P(2,1)+0.5454*P(2,2)).

As φ=0.22, we have

Target=0.78P(1,1)+0.1P(2,1)+0.12P(2,2).

As discussed with respect to Table 4, the cell into which (Y(1),φ) falls is used to address the weights. Depending on the latency with which the weights are chosen, it may be necessary to store the address of the weights used for sub-pixel interpolation along with the relative shift.

Table 6 lists the relative incremental shifts needed to achieve transition segment alignment for the first matched segment.

TABLE 6
Shift Table for Alignment Controller entries for phase adjusted
feature alignment for φ = 0.22 (79.2 degrees).

| | | | | | |
|---|---|---|---|---|---|
| Index (Kₚ) | 5 | 6 | 7 | 8 | 9 |
| Row 1 | 0 | 0 | 0 | 0 | 0 |
| (Shift) | | | | | |
| Row 2 | 0 | 4 | 5 | 4 | 1 |
| (Shift) | | | | | |

In this section we will examine the behavior of one aspect of the shift computation in more detail. The relative shift is governed by the equation

K₁(Kₚ)=(Kₚ−K₀)/φ+K₀, K₀ [symbol] Kₚ [symbol] K₁.

We may, without loss of generality, assume that K₀=0. The equation can be simplified to read

K₁(Kₚ)=Kₚ/φ, 0 [symbol] Kₚ [symbol] K₁.

Clearly, in order to compute the required (relative) shift, the phase φ must be inverted. Inversion is expensive, so instead, inverted values of the phase are quantized and stored as shown in Table 7 where we have cut the interval 0 to 1 into 8 segments of equal width. Each row contains an approximation to the inverted phase for a segment. The numbers are stored on chip in binary format.

TABLE 7
Inverted phase shift table.

| Quantized Phase φ | Inverse of Quantized Phase 1/φ |
|---|---|
| (0,1/8] | 8 |
| (1/8,2/8] | 4 |
| (2/8,3/8] | 2.66666 |
| (3/8,4/8] | 2 |
| (4/8,5/8] | 1.6 |
| (5/8,6/8] | 1.33333 |
| (6/8,7/8] | 1.14285 |
| (7/8,1) | 0 |

The inverted phase table is stored in fixed-point representation, but can be also stored in another representation, such as floating point. The inverted phase is the required relative shift used to align the features. The Accumulated Shift (AS) is used to sum up successive shifts and is also used to determine when shifting should cease. Shifting ceases when the subsequent pivot pixel is encountered. Logic is used to determining the relative shift at the boundary conditions, namely, at 0 and at 1. For example, if the phase is 0, then we may to forgo a shift entirely, or alternatively, we could decide to shift by K₁−K₀ in one step. When the phase is 1, similar logic can decide the desired amount of the relative shift.

Alignment Recovery (AR) is the process of bringing the filter back to vertical Restoring the default orientation means that the relative shifts initially used to align transitions segments must now be undone. This occurs immediately following the alignment of a transition segment. The alignment recover process is opposite to the alignment process. The subsequent pivot pixel is used to steer the filter towards a nominal orientation. Thereafter, barring the emergence of other matched transition segments, the default step size (time increment) is one pixel horizontally (vertically) when interpolating vertically (horizontally).

Other anticipated alignment strategies can be envisioned that generalize the role of the pivot pixel. For instance, rather than to use the pivot pixel repeatedly in the transition region, we can also stagger the pivot about a number of pixels both before and after the pivot pixel. This is sometimes useful when smoother transitions are required between features.

An important element of the foregoing discussion is the role of noise. There are many types of noise with which we must contend during the feature extraction, comparison and alignment processes. For instance, we can refer to pulse noise which is noise of a certain magnitude and duration. Pulse noise is not a feature and as such should not influence the behavior of the Alignment Controller.

A Feature Extractor will search for Pulse noise. This kind of noise rejection serves to establish the degree to which the current image is noisy. This information can be incorporated into the selection of filters and threshold dynamically rendering the entire chip truly adaptive in nature.

It is important to identify noise either using a separate Feature Extractor or as part of the current feature extractors so that noise is not classified as a feature This may result in a Matched Table entry that may result in a possible unwanted shift alignment.

Texture Noise is characterized by frequent changes in the direction (changes in Δ) of the image data on a row of a specific size and duration. These changes may be considered visually insignificant because they are of short duration or of small magnitude as measured by user-defined thresholds. A Feature Extractor can be designed and used to determine the degree to which the surface is textured.

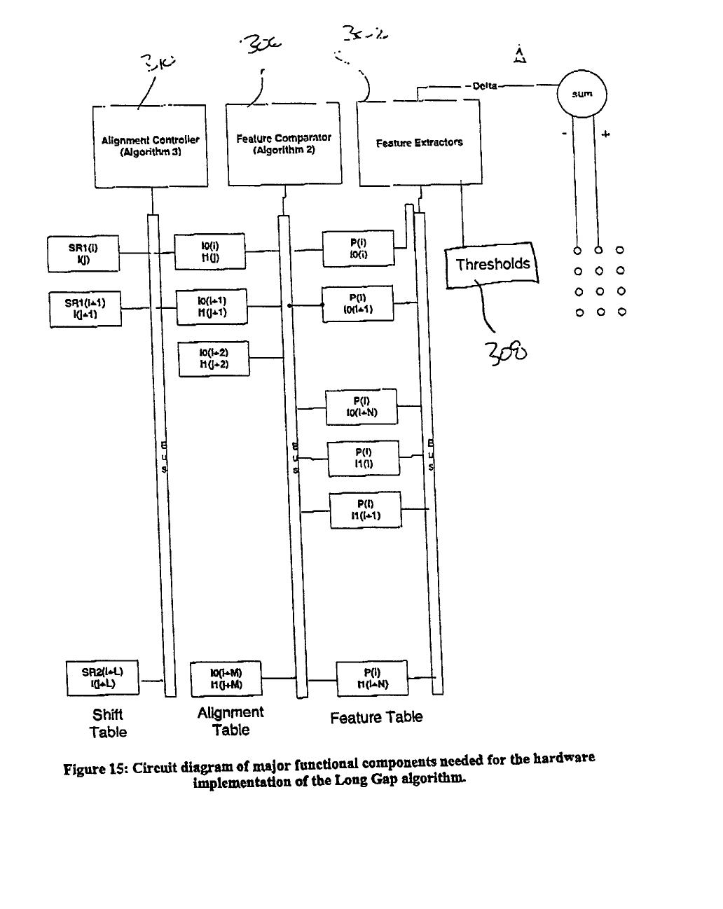

Referring to FIG. 15 there is shown a circuit diagram depicting the relationship between the major functional components described above. The Feature Extractor (FE) is comprised of N storage locations for the Segment Table each containing: a starting pixel intensity; a starting pixel index; an ending pixel intensity and an ending pixel location.

Each specific feature of interest, which is to be identified, requires a specific state machine. The Feature Comparator (FC) consists of M storage locations for the Matched Table containing: matched trend segments in pairs and a flag indicating a non-transition segment. The feature comparator implements the match acquisition process flow described with reference to FIG. 11. The Alignment Controller (AC) consists of P storage locations for the Alignment Table each containing: the relative shift needed for row 1 or row 2; the relative positions at which the relative shift is to occur, information to choose the correct weights for sub-pixel interpolation; A phase inversion table for relative shift computation and accumulators and decision circuitry for alignment decisions.

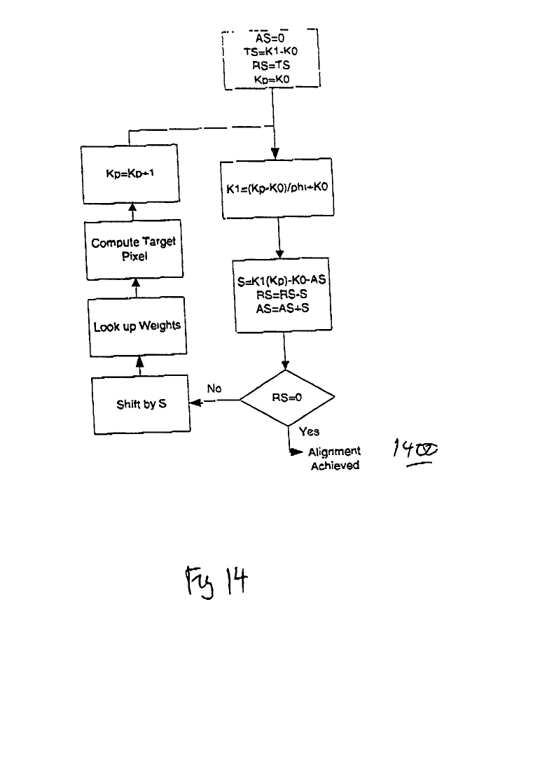

The circuit to implement the relative shifts consists of fixed-point division addition and logic circuits for implementing the flow described with reference to FIG. 14.

The terms and expressions which have been employed in the specification are used as terms of description and not of limitations, there is no intention in the use of such terms and expressions to exclude any equivalents of the features shown and described or portions thereof, but it is recognized that various modifications are possible within the scope of the claims to the invention.

The embodiments of the invention in which an exclusive property or privilege is claimed are defined as follows:

1. An interpolator for processing an image comprised of an array of pixels, the interpolator comprising:
(a) a feature extractor for processing a pixel sequence contained in the array of pixels to extract visually significant features therein;
(b) a feature comparator for matching similar extracted features in adjacent pixel sequences; and
(c) an alignment controller using said matched features to select visually most relevant source pixels to generate a target pixel.

2. An interpolator as defined in claim 1, said feature extractor including a state machine.

3. An interpolator as defined in claim 1, said feature comparator including a correlator for determining said feature similarities.

4. An interpolator as defined in claim 1, said alignment controller generating said target pixel position by computing a sequence of relative shifts between adjacent rows.

5. A method for interpolating a target pixel in an array of source pixels, comprising the steps of:
(a) processing rows of the array to identify sequences of pixels characterizing visually significant features;
(b) matching similar features in adjacent rows and;
(c) using said matched features to select visually most relevant source pixels to generate a target pixel.
